(19) United States
(12) Patent Application Publication
(10) Pub. No.: US 2011/0214619 A1
(43) Pub. Date: Sep. 8, 2011

(54) LIGHTING SYSTEM WITH ANIMAL TRAINING DEVICE

(75) Inventors: Robert Risch, Auburn, WA (US); Kee Leung, Mercer Island, WA (US)

(73) Assignee: GOLDEN CREST TRADING, INC., Auburn, WA (US)

(21) Appl. No.: 12/717,768

(22) Filed: Mar. 4, 2010

(51) Int. Cl. A01K 15/02; F21L 4/00; F21L 4/02

(52) U.S. Cl. 119/719; 362/157; 362/184

(57) ABSTRACT

A flashlight system includes an animal training device and optionally one or more beacon lights to provide visibility in multiple directions. The light for the flashlight and the beacon lights are in electronic communication with a power source, such as a battery, for the flashlight. The light and the beacon lights may take the form of light emitting diodes (LEDs). The flashlight system includes an ergonomically contoured, waterproof body with a recessed region to receive at least a portion of the animal training device, which may take the form of a dog clicker that generates an audible sound. The light for the flashlight may have a different on/off switch than that of the beacon light.

### FIELD OF THE INVENTION

This invention relates generally to a lighting system with an animal training device, and more specifically to a handheld lighting system with an animal training device.

### SUMMARY OF THE INVENTION

A flashlight integrated with an animal training device may include one or more beacon lights in electronic communication with a power source for the flashlight. In one embodiment, the flashlight includes an ergonomically curved waterproof flashlight body combined with a dog clicker and at least one beacon light. The flashlight may have a contoured body that is more comfortable to hold while providing an easily accessible animal training device that generates an audible sound. The light for the flashlight may have a different on/off switch than that of the beacon light. In one embodiment, the beacon light may be a flashing, safety light.

In one aspect of the invention, a lighting system includes an animal training device having a deflectable member; and a flashlight device having a body with a recess defining a spatial volume sufficient to permit an audible sound during a process of pressing and releasing the deflectable member, the deflectable member supported by the body around a peripheral region of the deflectable member.

In another aspect of the invention, a training device for low light conditions includes an audible noise-making device; a beacon light; and a flashlight having a body with a recess configured to insertably receive at least a portion of the audible noise-making device, the beacon light arranged on the body and in electronic communication with a power source for the flashlight.

### BRIEF DESCRIPTION OF THE DRAWINGS

Preferred and alternative embodiments of the present invention are described in detail below with reference to the following drawings.

FIG. 1A is perspective view of a flashlight system having an animal training device and at least one beacon light according to an embodiment of the present invention;

FIG. 1B is side, elevational view of the flashlight system of FIG. 1A;

FIG. 2 is top, plan view of the flashlight system of FIG. 1A; and

FIG. 3 is cross-sectional view of the flashlight system of FIG. 1A taken along line 3-3 of FIG. 2 according to an embodiment of the present invention.

### DETAILED DESCRIPTION OF THE PREFERRED EMBODIMENTS

The present invention relates to a flashlight integrated with an animal training device and optionally one or more beacon lights. Because walking a dog in the evening or during low-light conditions may be unsafe, the present invention provides additional visibility in multiple directions at the same time, while consolidating a flashlight, an animal training device and beacon lights into a system that is easy to carry by hand and may be readily manipulated. The light for the flashlight and the beacon lights are in electronic communication with a power source, such as a battery, for the flashlight. The light and the beacon lights may take the form of light emitting diodes (LEDs). In one embodiment, the flashlight includes an ergonomically contoured, waterproof body with a recessed region to receive at least a portion of the animal training device, which may take the form of a dog clicker that generates an audible sound, such as a clicking sound. The light for the flashlight may have a different on/off switch than that of the beacon light. In one embodiment, the beacon light may be a flashing, safety light.

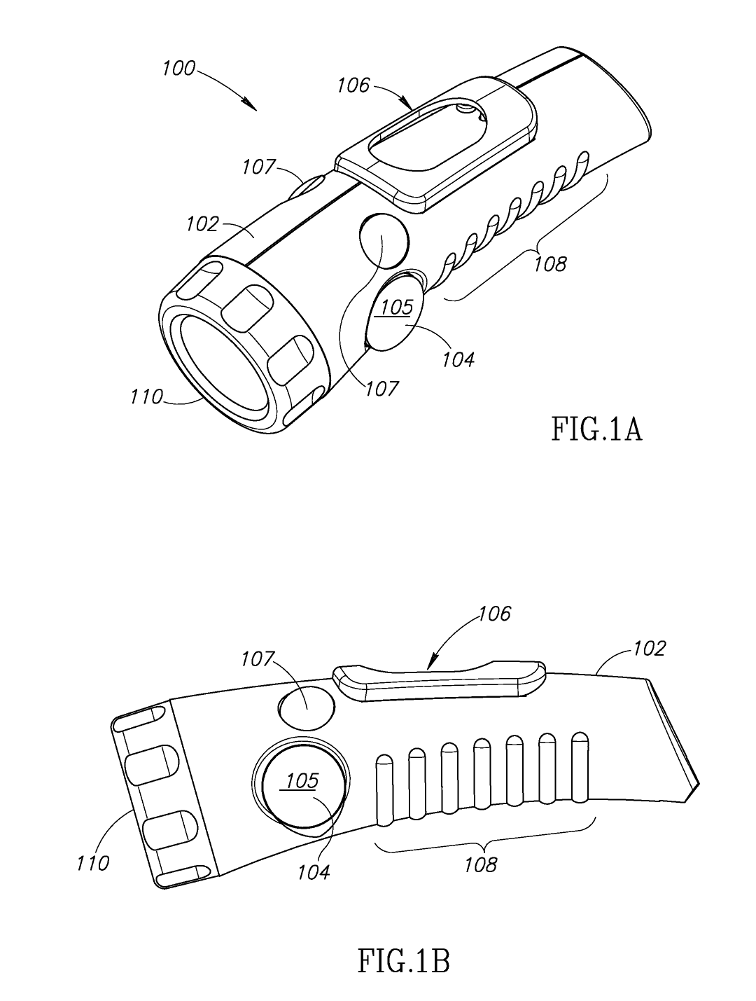

FIGS. 1A and 1B show a flashlight system 100 having an ergonomically contoured body 102, at least one beacon light 104, and an animal training device 106. The body 102 may include ridges or ribs 108 to prevent slippage of the body 102 when grasped. The flashlight system 100 further includes a removable cover or cap 110 threadably coupled or otherwise attached to the body 102. The body 102 and cap 110 may be sealed to make the flashlight system 100 sufficiently waterproof for use in rainy or damp weather conditions. The ribs 108 may be made from an overmolded rubber material. Other parts of the body 102 and cap 110 may also be made from or covered in an overmolded rubber material to increase the grippability of the flashlight system 100.

The beacon light 104 may include a cover or lens 105 for changing a color of the light emitted from the flashlight system 100 through the beacon light 104. Power buttons 107 may be arranged on either side of the body 102, such that the power buttons 107 in combination with the arrangement of the ribs 108 make the flashlight system 100 both right and left handed.

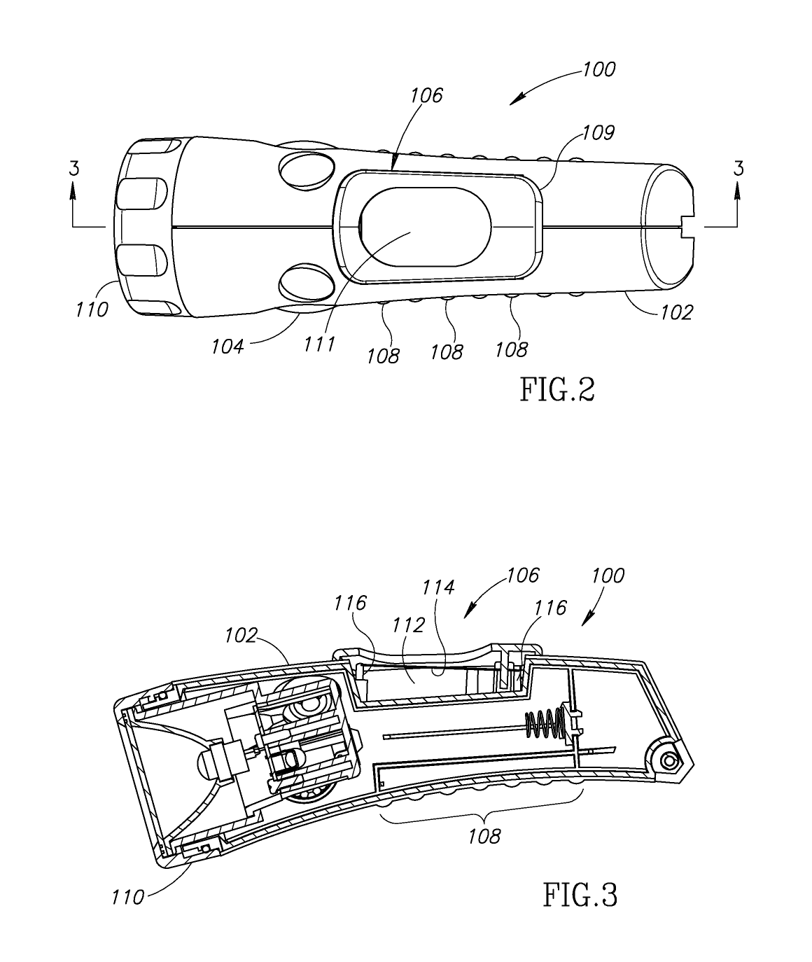

FIGS. 2 and 3 shows the flashlight system 100 coupled to its working components within the body 102. FIG. 2 shows the animal training device 106 includes a cover 109 with an opening 111 sized to receive a digit, such as a portion of a finger. Referring now to FIG. 3, the body 102 includes a recess or cavity 112 configured to receive the animal training device 106. In one embodiment, the device 106 includes a deflectable membrane 114 arranged over the recess 112 and supported at each end by posts 116 or similar structural members. The deflectable membrane 114 may take the form of a metallic diaphragm or plate having a shape such that when pressed a center portion of the plate may deflect relative to the fixed edge portions to generate an audible sound. In operation, the deflectable membrane 114 may function similar to a Belleville spring or cone spring, although the contouring of the membrane 114 may be visibly unnoticeable. Stated otherwise, the membrane 114 may operate as a linear elastic spring having an elastic memory that permits the center portion to be pressed over-center.

In another embodiment, the deflectable membrane 114 takes the form of a substantially planar metallic panel or sheet bent in such a way that when pressed it generates the audible sound. The sheet is secured to allow the metal to be bent against its original bends, and thus when pressed makes the audible sound.

While the preferred embodiments of the invention have been illustrated and described, as noted above, many changes can be made without departing from the spirit and scope of the invention. Accordingly, the scope of the invention is not limited by the disclosure of the preferred embodiments. Instead, the invention should be determined entirely by reference to the claims that follow.

The embodiments of the invention in which an exclusive property or privilege is claimed are defined as follows:

1. A lighting system comprising:
an animal training device having a deflectable member; and
a flashlight device having a body with a recess defining a spatial volume sufficient to permit an audible sound during a process of pressing and releasing the deflectable member, the deflectable member supported by the body around a peripheral region of the deflectable member.

2. The lighting system of claim 1, wherein the body is contoured to be comfortably gripped by hand.

3. The lighting system of claim 1, further comprising a beacon light in electrical communication with a power source within the body of the flashlight device.

4. The lighting system of claim 3, wherein the beacon light is arranged to provide an illuminating safety light projected in a direction that is different than a projected direction of a light beam of the flashlight device.

5. The lighting system of claim 1, further comprising ridged grippable members arranged on the body of the flashlight device.

6. The lighting system of claim 1, further comprising a first power button for operating a light of the flashlight device and a second power button for operating at least one beacon light.

7. The lighting system of claim 1, further comprising a power button for operating a light of the flashlight device and for operating at least one beacon light.

8. The lighting system of claim 1, wherein the deflectable member spans an opening formed by the recess of the body.

9. The lighting system of claim 1, wherein the body includes a structural post for supporting the peripheral region of the deflectable member.

10. The lighting system of claim 1, wherein the recess is located adjacent to a battery compartment within the body of the flashlight device.

11. A training device for low light conditions, the device comprising:
an audible noise-making device;
a beacon light; and
a flashlight having a body with a recess configured to insertably receive at least a portion of the audible noise-making device, the beacon light arranged on the body and in electronic communication with a power source for the flashlight.

12. The training device of claim 11, wherein the body is contoured to be comfortably gripped by hand.

13. The training device of claim 11, wherein the audible noise-making device is a clicker for training one or more animals.

14. The training device of claim 11, wherein the beacon light includes an illuminating safety light projected in a direction that is different than a projected direction of a light beam of the flashlight.

15. The training device of claim 11, further comprising ridged grippable members arranged on the body of the flashlight.

16. The training device of claim 11, further comprising a first power button for operating a light of the flashlight and a second power button for operating the beacon light.

17. The training device of claim 11, wherein the audible noise-making device includes a deflectable member.

18. The training device of claim 17, wherein the deflectable member is a linear elastic metallic member having an over-center deflectable center portion.

19. The training device of claim 11, wherein the recess is located adjacent to a battery compartment within the body of the flashlight.
